(19) United States
(12) Patent Application Publication
(10) Pub. No.: US 2018/0126434 A1
(43) Pub. Date: May 10, 2018

(54) METHOD AND MACHINE FOR BENDING METAL INCLUDING LOCKING MECHANISM FOR ADJUSTABLE DIE

(71) Applicant: Accurpress America Inc., Rapid City, SD (US)

(72) Inventors: Stephen Hilton, Rapid City, SD (US); Allen Guernsey, Rapid City, SD (US)

(73) Assignee: Accurpress America Inc., Rapid City, SD (US)

(21) Appl. No.: 15/807,524

(22) Filed: Nov. 8, 2017

Related U.S. Application Data
(60) Provisional application No. 62/419,290, filed on Nov. 8, 2016.

(51) Int. Cl. B21D 5/02; B30B 15/02

(52) U.S. Cl. CPC B21D 5/0227; B30B 15/026

(57) ABSTRACT

A press brake for bending a workpiece. The press brake a movable ram and a support beam. A punch is connected to the ram, and a die is connected to the support beam. The punch and the die are separated by a gap and the workpiece is placed in the gap in order to be bent. The ram is configured to be driven towards the support beam to thereby close the gap between the punch and the die. The die includes a pair of die members extending in a longitudinal direction separated by a recess having a width in a lateral direction perpendicular to the longitudinal direction. The width of the recess is adjustable by moving the die members. The die members are configured to move vertically to disengage from the support beam to thereby allow for lateral movement of the die members to adjust the width of the recess.

### CROSS REFERENCE TO RELATED APPLICATION

This application claims priority to and the benefit of U.S. Provisional Patent Application No. 62/419,290 entitled Method and Machine for Bending Metal and filed on Nov. 8, 2016. The foregoing provisional application is incorporated by reference herein in its entirety.

### BACKGROUND

The application relates generally to press brakes and, in particular, a press brake that includes a structure and mechanism for adjusting the width of a die.

A press brake machine or device is used as a tool to make precise bends in metal parts. Generally, a sheet of metal is placed within the machine and positioned precisely using a gauge. A punch, which often has the shape of a “V”, is placed against the metal sheet at the point where a bend is required. A punch is pressed into the metal sheet, which in turn is pressed into the die causing the sheet to bend. Frequently, the press brake machine is configured so that die and the punch are long enough to contact the entire length or width of the sheet.

A press brake machine may be configured so that a forming die mounted on a bed may be “U” or “V” shaped. The die may include a pair of dies or half dies, for example. The distance between the dies may be adjusted so that the bearing areas for the metal part or work piece being formed can be adjusted according to the forming requirements for the work piece.

### BRIEF DESCRIPTION OF THE DRAWINGS

Features, aspects, and advantages of the present invention will become apparent from the following description, appended claims, and the accompanying exemplary embodiments shown in the drawings, which are briefly described below.

FIG. 1 is a front and right side perspective view of a press brake machine.

FIG. 2 is a left and rear perspective view of the press brake machine of FIG. 1.

FIG. 3 is a left, top and front perspective view of a portion of a base plate and movable die for a press brake machine.

FIG. 4 is an end view showing the movable die in the locked position.

FIG. 5 is an end view showing the movable die in the unlocked position.

FIG. 6 is a side view of a base plate and movable die in the unlocked position.

FIG. 7 is a side view of the base plate and movable die of FIG. 6.

FIG. 8 is a detailed view of the encircled B area of FIG. 7.

FIG. 9 is a detailed view of the encircled C area of FIG. 6.

FIG. 10 is a side view of a base plate and movable die in the locked position.

FIG. 11 is a side view of the base plate and movable die of FIG. 6.

FIG. 12 is a detailed view of the encircled B area of FIG. 11.

FIG. 13 is a detailed view of the encircled C area of FIG. 10.

FIG. 14 is a left, top and front perspective view of the hydraulic actuator and linear rail for adjusting the position of the die.

### DESCRIPTION

Various features of the present invention will be described with reference to the drawings. Like numbers are used throughout the drawings to refer to the same or similar parts and in each of the embodiments of the invention hereafter described.

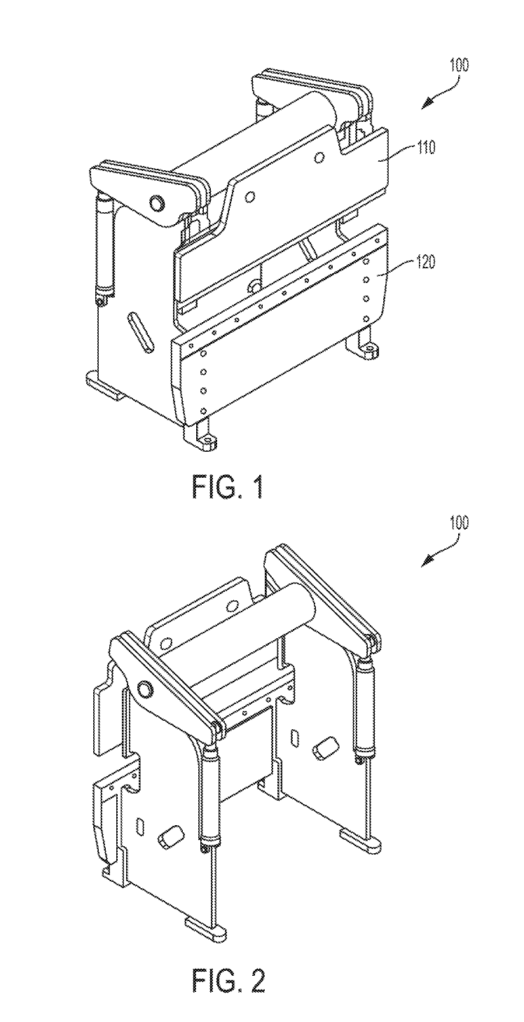

The press brake disclosed herein is used to bend or otherwise deform sheet-like work pieces, such as sheet metal work pieces. As shown in FIGS. 1 and 2, a press brake 100 has an upper beam 110 and a lower or support beam 120, at least one of which is movable toward and away from the other. Preferably, the upper beam is movable vertically while the lower beam is fixed in a stationary position. As an example, a male forming punch and a female forming die may be mounted respectively on the upper and lower beams of a press brake.

The punch has a downwardly-oriented, work piece-deforming surface (or “tip”). The configuration of this surface is dictated by the shape into which it is desired to deform a work piece. The die has a recess between the die members and bounded by one or more work piece-deforming surfaces that is aligned with the tip of the punch. The configuration of this recess corresponds to the configuration of the punch's tip. Thus, when the beams are brought together, a work piece between them is pressed by the punch into the die to give the work piece a desired deformation (e.g., a desired bend).

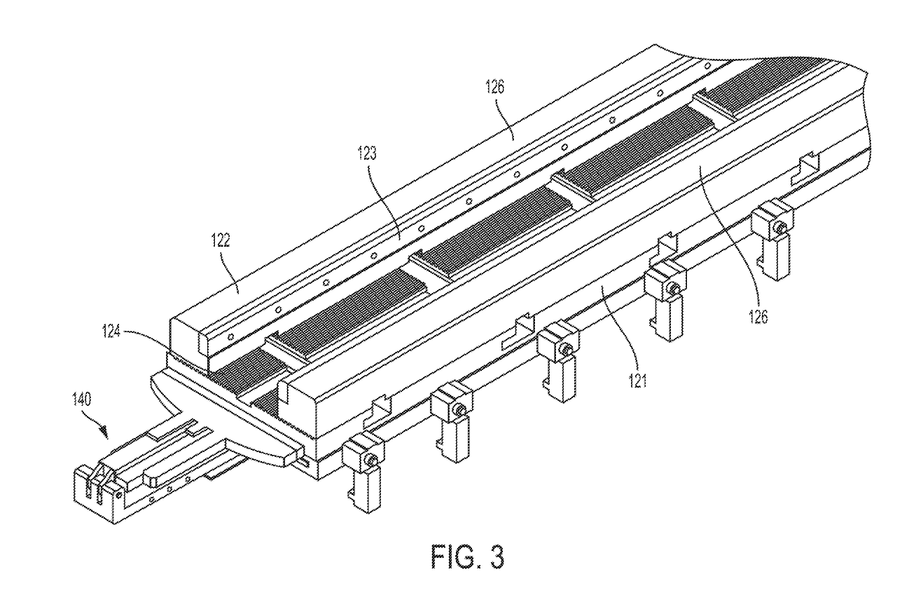

The lower support beam or bed may include a base plate 121 that supports and engages with a movable upright 122. The upright 122 may carry an insert 123 positioned to contact the work piece during the bending operation. The upright 122 and insert 123 form a die member 126 that may be adjustable to meet the requirements of the bending operation. As shown in FIG. 3, the top surface of the base plate 121 may be a saw toothed or grooved surface 124, for example, for engaging the bottom surface of the movable die. The bottom surface of the upright 122 may be a corresponding saw toothed or grooved surface 125 for interlocking and engaging the top surface 124 of the base plate 121. As shown in the figures, the press brake includes a pair of die members 126 and a corresponding punch that moves downwardly between the die members to bend the work piece. The relative separation or width between the dies 126 can be adjusted when the uprights 122 are unlocked from the base plate 121.

The lower bed includes a locking and unlocking mechanism for locking and unlocking the die and the base plate. The locking mechanism includes a plurality of locking dog members 130 that engage both the base plate and the dies. See, for example, FIGS. 9 and 13 which show the dog members 130 located in a cutout portion 131 of the base plate 121. The bottom surface of the cutout portion 131 includes a ramped surface 132. The position of the dog members 130 and movable upright 122 may be changed using a hydraulic actuator 140 (see FIG. 3). The cutout portion 131 includes a locking groove 135 for receiving the dog member 130 when the die is locked. The cutout portion 131 also includes an unlocking groove 137 for receiving the dog member 130 when the die is unlocked or disengaged from the base plate.

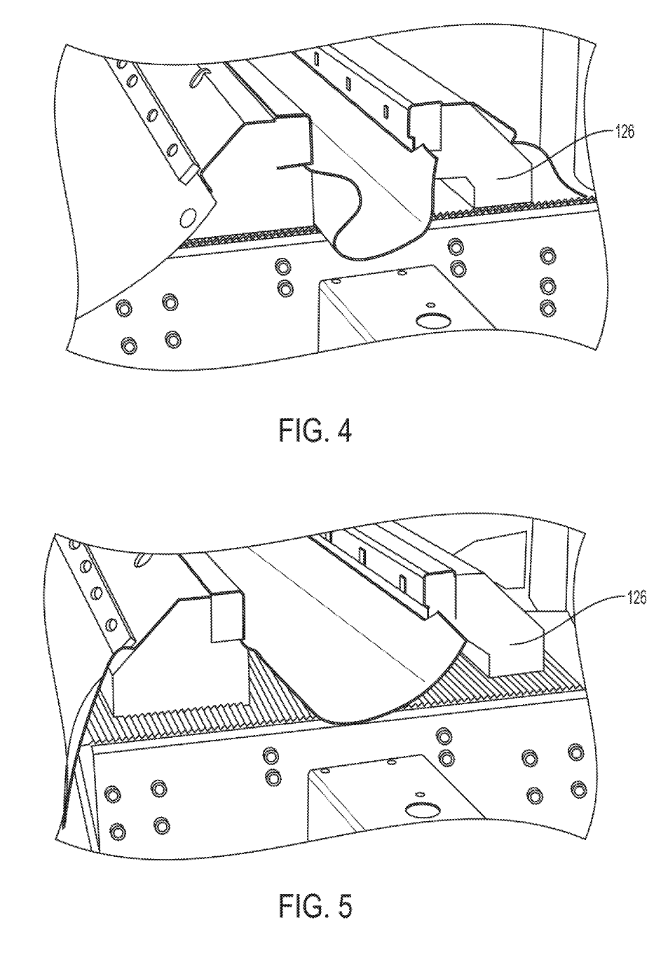

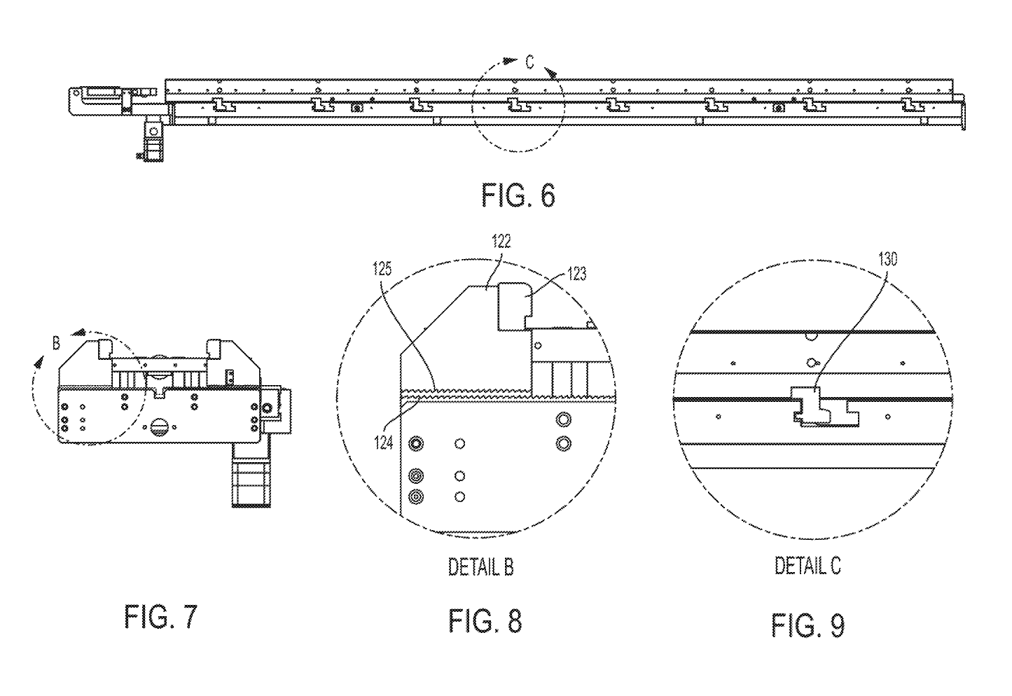

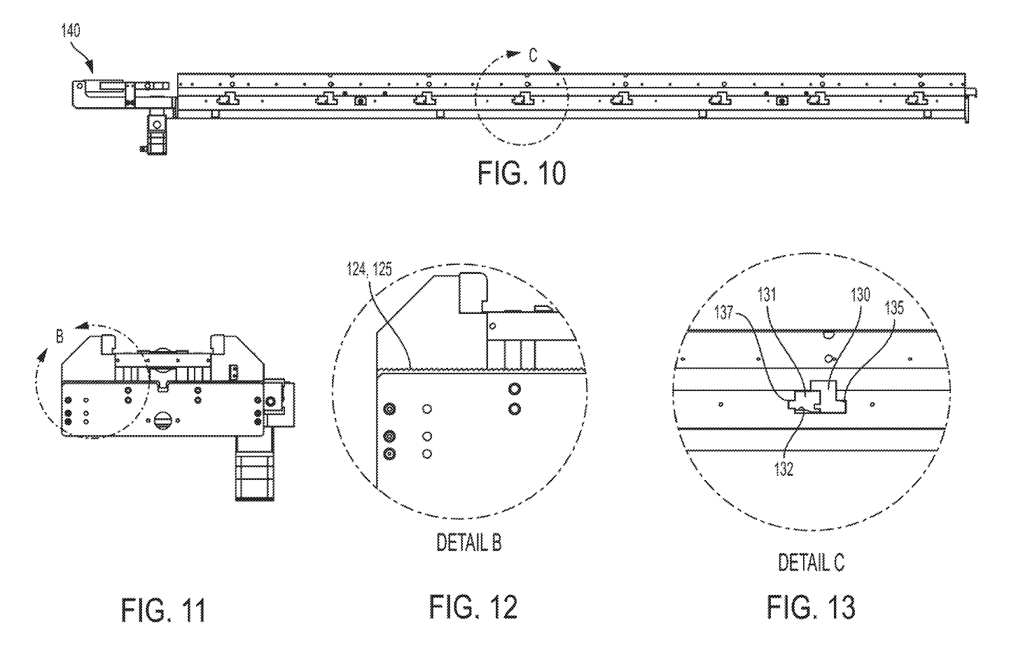

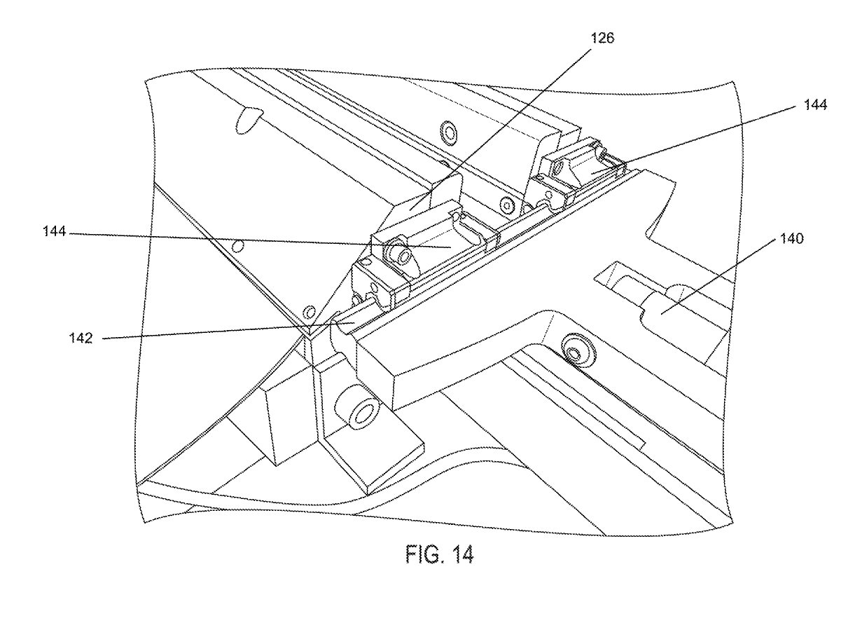

Movement of the actuator causes a corresponding longitudinal movement (i.e., parallel to the length of the die) of the movable uprights 122 and connected dogs 130. FIGS. 4 and 5 show the movement of the die members 126 in the longitudinal and vertical direction between the locked and unlocked position. FIGS. 4 and 5 show an optional plastic cover located in the recess between the die members for the collection mill scale from the workpiece. The cover is flexible and moves with the die members 126 when the width of the recess changes. In addition, in the unlocked position, the vertical separation between the upright 122 and the base plate 121 can be seen in FIGS. 5 and 8. The movable dog members 130 may be integrally connected to the die members 126. The die members 126 may be driven longitudinally by an actuator 140 (e.g., a hydraulic piston cylinder actuator) as shown, for example in FIG. 14. The die members 126 may be connected to a linear rail 142 via connecting blocks 144 to allow for lateral movement of the die members and adjustment of the width of the recess, as shown in FIG. 14. The rail 142 and connecting blocks 144 move longitudinally with the die members when the actuator 140 is activated to disengage the upright or riser 122 from the base plate 121. When the movable upright 122 and the dog member 130 moves from the locked position shown in FIG. 13 to the unlocked position shown in FIG. 9 the dog member 130 moves across the ramped surface 132 causing the dog member 130 and the movable upright 122 to move vertically upward.

The upward movement of the dog member 130 causes a corresponding upward movement of the upright 122. As a result, the top surface 124 of the base plate 121 disengages from the bottom surface 125 of the upright 122. In the unlocked position, the vertical separation between the upright 122 and the base plate 121 can be seen in FIGS. 5 and 8. While unlocked, the lateral position of the dies 126 may be adjusted using a suitable actuator (e.g., a hydraulic actuator, a motor driving a rotating shaft connected to a lead screw, or a rack and pinion and/or including an optional gear box and/or a linkage) or other appropriate mechanism. The lateral movement is facilitated by, for example, the linear rail 142 shown in FIG. 14. As a result, the width of the recess formed by the die between the die members 126 may be increased or decreased while the uprights 122 are unlocked.

Although not shown in FIG. 3, the actuator may be directly connected to the upright members 122. The upright members 122 may be engaged to a longitudinal push/pull member in a manner that also permits lateral movement of the upright members (e.g., a sliding hook and groove type connection).

The inserts 123 may be formed from strength hardened material in order to provide extra heavy load capacities and longer tool life. The inserts 123 can be replaced when needed, preserving the entire tool unit from tool wear. The press brake described herein eliminates the time, energy and storage space required in using and changing large bottom tools. The dies 126 can be adjusted eliminating the need to undertake a complete tool change out. The press brake provides all required sizes of “V” openings (i.e., Vee target, or die V opening) needed in one tool unit. The size of the recess can be as small as .5 inches, for example making it a suitable die holder for all standard bottom tools. In addition, the dies may be separated to provide adequate clearance to produce 90 degree bends. For example, larger profiles may be provided allowing for openings beyond 14 in.

According to one embodiment disclosed herein a press brake is provided. The press brake includes a movable ram and a support beam, wherein the ram and the support beam are connected to a supporting frame. The support beam includes a base plate for supporting a die. The die includes a pair of movable upright members separated to form a punch receiving recess therebetween. The size of the recess may be adjusted by moving the upright members. The upright members are connected to the base plate by a riser positioned in a cutout portion of the base plate. The upright members are configured to simultaneously be moved longitudinally and vertically to create a separation between the upright member and the base plate. The upright members are configured to move laterally when the upright members are separated from the base plate.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described are considered to be within the scope of the invention.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “fore,” “aft,” “inboard,” “outboard,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the press brake shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A press brake for bending a workpiece comprising:
a movable ram and a support beam, wherein the ram and the support beam are connected to a supporting frame;
a punch connected to the ram, and a die connected to the support beam;
wherein the punch and the die are separated by a gap and wherein the press brake is configured to receive the workpiece in the gap;
wherein the ram is configured to be driven towards the support beam to thereby dose the gap between the punch and the die;
wherein the die includes a pair of die members extending in a longitudinal direction separated by a recess having a width in a lateral direction perpendicular to the longitudinal direction, wherein the width of the recess is adjustable by moving the die members; and
wherein the die members are releasably engaged with the support beam, and wherein the die members move vertically to disengage from the support beam to thereby allow for lateral movement of the die members to adjust the width of the recess.

2. The press brake of claim 2, further comprising a movable dog member connected to the die members, wherein the dog member moves to disengage and engage the die members from the support beam.

3. The press brake of claim 2, wherein the dog member moves in the vertical and longitudinal direction.

4. The press brake of claim 3, wherein dogs member moves between a locked position and an unlocked position, and wherein in the locked position the die members are engaged with the support beam and wherein in the unlocked position the die members are disengaged with the support beam and free to move laterally.

5. The press brake of claim 4, wherein in the locked position the dog member fits into a. locking groove in the support beam.

6. The press brake of claim 5, wherein in the unlocked position the dog member fits into a unlocking groove in the support beam.

7. The press brake of claim 4, wherein the support beam includes a ramped surface and wherein when the dog member moves from the locked to the unlocked position the dog member slides along the ramped surface to move both longitudinally and vertically upward.

8. The press brake of claim 7, wherein in the locked position the dog member fits into a locking groove in the support beam.

9. The press brake of claim 8, wherein in the unlocked position the dog member fits into a unlocking groove in the support beam.

10. The press brake of claim 9, wherein the ramp surface is located between the locking groove and the unlocking groove.

11. The press brake of claim 4, wherein the die members include a notched surface that engages a corresponding notched surface in the support beam and wherein when the dog member moves from the locked position to the unlocked position the notched surface of the die member and the notched surface of the support beam become disengaged.

12. The press brake of claim 7, wherein the die members are attached to the dog member so that the die members move vertically upward with the dog member to disengage from the support beam.

13. An adjustable die for a press brake including a ram and a support beam comprising:
a pair of movable die members extending in a longitudinal direction separated by a recess having a width in a lateral direction perpendicular to the longitudinal direction, wherein the width of the recess is adjustable by moving the die members;
wherein the die members are releasably engaged with the support beam and wherein the die members move vertically to disengage from the support beam to thereby allow for lateral movement of the die members to adjust the width of the recess; and
a movable dog member connected to the die members that moves to lock and unlock the die members from the support beam.

14. The adjustable die of claim 13, wherein dog member moves between a locked position and an unlocked position, and wherein in the locked position the die members are engaged with the support beam and wherein in the unlocked position the die members are disengaged with the support beam and free to move laterally.

15. The adjustable die of claim 14, wherein the die members include a notched surface that engages a corresponding notched surface in the support beam and wherein when the dog member moves from a locked position to an unlocked position the notched surface of the die member and the notched surface of the support beam become disengaged.

16. The adjustable die of claim 15, wherein in the locked position the dog member fits into a locking groove in the support beam.

17. The adjustable die of claim 16, wherein in the unlocked position the dog member fits into a unlocking groove in the support beam.

18. The adjustable die of claim 17, wherein the support beam includes a ramped surface and wherein when the dog member moves from the locked to the unlocked position the dog member slides along the ramped surface to move both longitudinally and vertically upward.

19. A press brake for bending a workpiece comprising:
a movable ram and a support beam, wherein the ram and the support beam are connected to a supporting frame;
a punch connected to the ram, and a die connected to the support beam;
wherein the punch and the die are separated by a gap and wherein the press brake is configured to receive the workpiece in the gap;
wherein the ram is configured to be driven towards the support beam to thereby close the gap between the punch and the die;
wherein the die includes a pair of die members extending in a longitudinal direction separated by a recess having a width in a lateral direction perpendicular to the longitudinal direction, wherein the width of the recess is adjustable by moving the die members; and
a movable dog member connected to the die members and engaged with the support beam, wherein the dog member moves from a locked position to an unlocked position to allow the width of the recess to be adjusted.

20. The press brake of claim 19, wherein in the locked position the die members are engaged with the support beam and wherein in the unlocked position the die members are disengaged with the support beam and free to move laterally
